(19) United States
(12) Patent Application Publication
(10) Pub. No.: US 2011/0032237 A1
(43) Pub. Date: Feb. 10, 2011

(54) CIRCUIT STRUCTURE

(76) Inventor: Cheng-Nan Lin, Hsinchu City (TW)

Correspondence Address: PATTERSON & SHERIDAN, LLP - Formosan Brothers, 3040 POST OAK ROAD, HOUSTON, TX, 77026, US

(21) Appl. No.: 12/849,144

(22) Filed: Aug. 3, 2010

(30) Foreign Application Priority Data
Aug. 4, 2009 (TW) 098126171

(51) Int. Cl. G06F 3/038

(52) U.S. Cl. 345/211

(57) ABSTRACT

A circuit structure suitable for coupling between a sample register and a digital-to-analog converter in a source driver circuit is disclosed. The circuit structure includes a multi-function switch circuit and a control unit. The multi-function switch circuit is coupled to an elevation voltage terminal and a system ground terminal. The multi-function switch circuit has a positive input pole, a negative input pole and a positive output pole. The control unit is coupled to the positive input pole and a negative input pole. The control unit selectively conducts a positive input signal and a negative input signal from the sample register to the positive input pole and the negative input pole respectively according to a latch control signal. Accordingly, the multi-function switch circuit of the invention has two functions of voltage shifting and data latching.

### BACKGROUND OF THE INVENTION

1. Field of the Invention

The invention relates to a circuit structure, and particularly to a circuit structure used in a source driver circuit.

2. Description of the Prior Art

With the rapid development of electronic display technology, various kinds of thin displays, such as thin-film transistor liquid crystal display (TFT-LCD) and active matrix organic light emitting diode (AMOLED), has become the electronic display apparatus widely used in families, companies or other occasions to display multi-media images.

In order to make the display apparatus to play real-time image information accurately, a driver circuit plays a very important role in the display apparatus. The driver circuit in the display apparatus is used to write each scan line into a corresponding register buffer in advance, and then to load each scan line message to the corresponding pixel loading in order according to a scan timing signal to generate a stable display effect.

Please refer to FIG. 1. FIG. 1 illustrates a functional block diagram of a conventional source driver circuit 1 in prior art. As shown in FIG. 1, the source driver circuit 1 can correspond to a plurality of scan lines (e.g., LINEO˜LINEx) at the same time. For each of the scan lines, the source driver circuit 1 includes a sample register 10, a data latching circuit 12, a voltage level shifter circuit 14, a digital-to-analog converter (DAC) 16, and an operational amplifier (OPAMP) 18 coupled in series.

Wherein, the data latching circuit 12 is controlled by a latch control signal LAT to read the signal (e.g., a positive input signal and a negative input signal D/DB) which is scheduled to be played from the sample register 10 and temporarily latch the signal in the data latching circuit 12 in a type of voltage signal.

Then, the voltage level shifter circuit 14 is used to further level up the voltage signal latched in the data latching circuit 12, and generate output signals corresponding to the following driving voltage range needed for the DAC 16 and the OPAMP 18.

Please also refer to FIG. 2. FIG. 2 illustrates a circuit diagram of the data latching circuit 12 and the voltage level shifter circuit 14 in prior art. As shown in FIG. 2, the circuit structures of the separately disposed data latching circuit 12 and voltage level shifter circuit 14 are complicated. The data latching circuit 12 needs a logic circuit of two inverters to achieve the latching effect, and the voltage level shifter circuit 14 also needs several transistor switch components with high-voltage resistance. Accordingly, the circuit structure using the above-mentioned separately disposed data latching circuit 12 and voltage level shifter circuit 14 has many drawbacks such as high setup cost, large circuit layout area, and limited data transmission efficiency.

Therefore, the invention provides a circuit structure which is applied in a source driver circuit and capable of being a multi-functional circuit structure having both functions of data latching and voltage level shifting to solve the above-mentioned problems.

### SUMMARY OF THE INVENTION

A scope of the invention is to provide a circuit structure applied in a source driver circuit, the source driver circuit includes a sample register and a digital-to-analog converter, and the circuit structure is coupled between the sample register and the digital-to-analog converter.

In a preferred embodiment, the circuit structure includes a multi-function switch circuit and a control module. The multi-function switch circuit is coupled to an elevation voltage terminal and a system ground terminal, and the multi-function switch circuit has a positive input pole, a negative input pole, and a positive output pole. The control module is coupled to the positive input pole and the negative input pole. The control module selectively conducts a positive input signal and a negative input signal from the sample register to the positive input pole and the negative input pole respectively according to a latch control signal.

Wherein, the multi-function switch circuit of the invention has at least two functions of voltage level shifter and data latching. When the multi-function switch circuit is used as a voltage level shifter circuit, the multi-function switch circuit controls an output state of the positive output pole according to the positive input signal and the negative input signal conducted to the positive input pole and the negative input pole. If the positive input pole is at high voltage level and the negative input pole is at low voltage level, the multi-function switch circuit conducts the elevation voltage terminal to the positive output pole to output an elevation voltage output signal; if the positive input pole is at low voltage level and the negative input pole is at high voltage level, the multi-function switch circuit conducts the system ground terminal to the positive output pole.

When the multi-function switch circuit is used as a data latching circuit, that is to say, when the control module floats the positive input pole and the negative input pole according to the latch control signal, the multi-function switch circuit is used for latching the voltage level of the positive output pole.

In another embodiment, the circuit structure includes a multi-function switch circuit and a control module. The multi-function switch circuit includes a positive input pole, a negative input pole, a first switch module, a second switch module, and a third switch module.

The first switch module is used for selectively coupling an elevation voltage terminal to the positive output pole or the negative output pole; the second switch module is used for selectively coupling a system ground terminal to the positive output pole or the negative output pole; the third switch module is controlled by a positive input signal and a negative input signal from the sample register, and used for selectively coupling the positive output pole or the negative output pole to the system ground terminal.

The control module includes a fourth switch module coupled between the third switch module and the system ground terminal or coupled among the positive output pole, the negative output pole, and the third switch module. The control module selectively conducts or shuts down the fourth switch module according to a latch control signal to make the positive output pole and the negative output pole capable of coupling to the system ground terminal via the third switch module and the fourth switch module or floating.

Wherein, when the multi-function switch circuit is used as a voltage level shifter circuit, the control module conducts the fourth switch module according to the latch control signal, the third switch module controls output states of the positive output pole and the negative output pole according to the positive input signal and the negative input signal. If the positive input pole is at high voltage level and the negative input pole is at low voltage level, the multi-function switch circuit conducts the elevation voltage terminal to the positive output pole to output an elevation voltage output signal; if the positive input pole is at low voltage level and the negative input pole is at high voltage level, the multi-function switch circuit conducts the system ground terminal to the positive output pole.

When the multi-function switch circuit is used as a data latching circuit, that is to say, when the control module shuts down the fourth switch module according to the latch control signal, the first switch module and the second switch module are used for latching the voltage level of the positive output pole and the voltage level of the negative output pole.

The advantage and spirit of the invention may be understood by the following recitations together with the appended drawings.

### BRIEF DESCRIPTION OF THE APPENDED DRAWINGS

FIG. 1 illustrates a functional block diagram of a conventional source driver circuit in prior art.

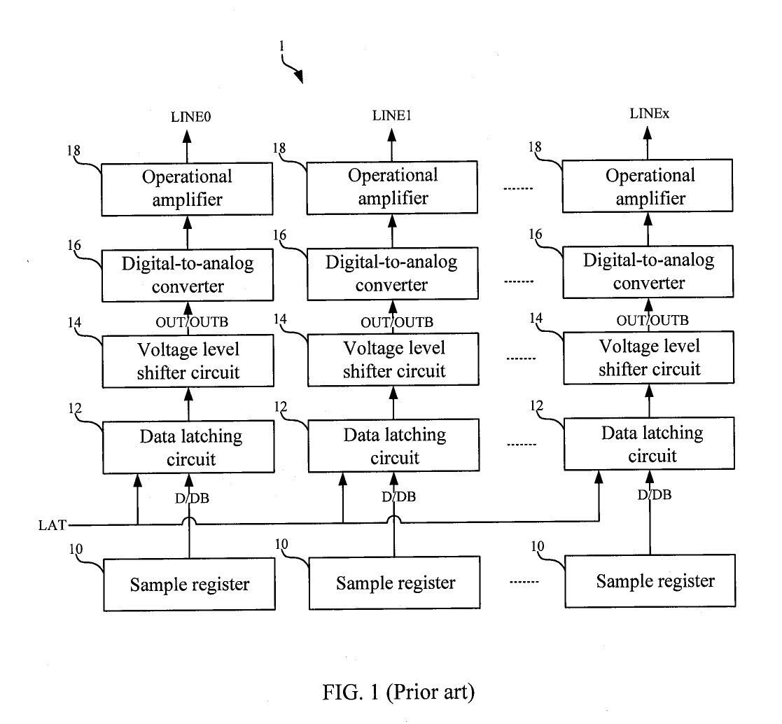

FIG. 2 illustrates a circuit diagram of the data latching circuit and the voltage level shifter circuit in prior art.

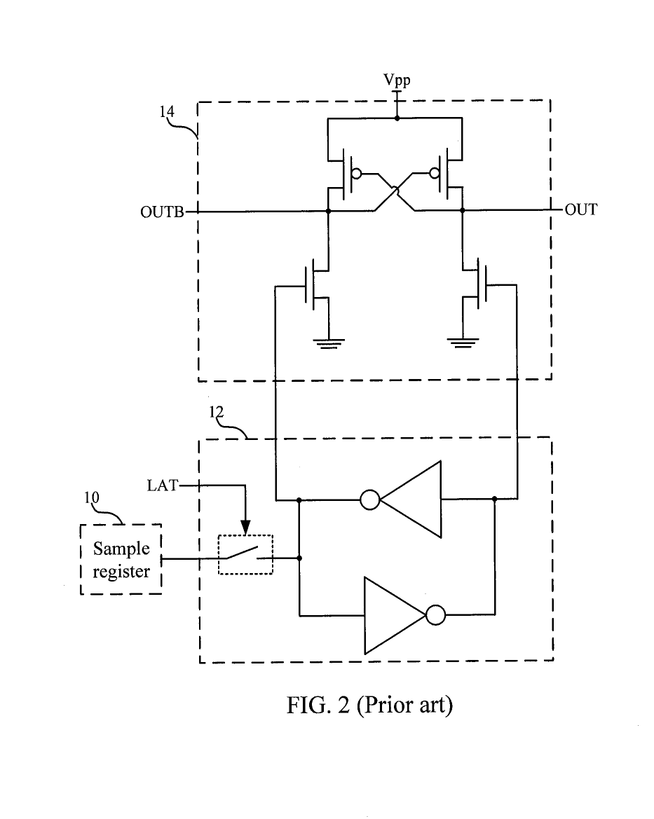

FIG. 3 illustrates a schematic diagram of the circuit structure and the source driver circuit in the first embodiment of the invention.

FIG. 4 illustrates a schematic diagram of the inner circuit of the circuit structure in the first embodiment of the invention.

FIG. 5A illustrates a schematic diagram of the inner circuit of the circuit structure in the second embodiment of the invention.

FIG. 5B illustrates a schematic diagram of the inner circuit of the circuit structure in the third embodiment of the invention.

### DETAILED DESCRIPTION OF THE INVENTION

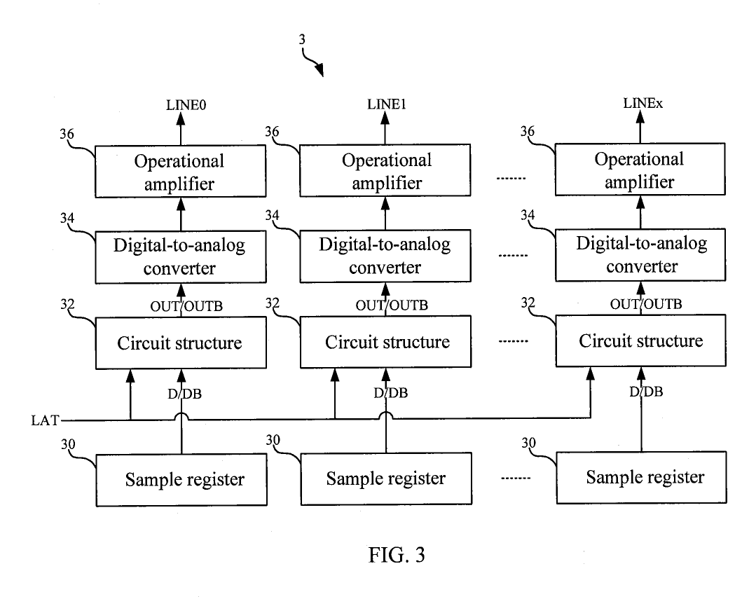

Please refer to FIG. 3. FIG. 3 illustrates a schematic diagram of a circuit structure 32 and a source driver circuit 3 in the first embodiment of the invention. In fact, the source driver circuit 3 can include a sample register 30, the circuit structure 32, a digital-to-analog converter (DAC) 34, and an operational amplifier (OPAMP) 36 orderly coupled in series.

As shown in FIG. 3, the circuit structure 32 can be coupled between the sample register 30 and the digital-to-analog converter 34 of the source driver circuit 3.

The circuit structure 32 can be controlled to achieve two functions of a data latching circuit and a voltage level shift circuit. As the data latching circuit, the circuit structure 32 can be controlled by a latch control signal LAT to read the signal (e.g., a positive input signal and a negative input signal D/DB) which is scheduled to be played from the sample register 30 and temporarily latch the signal in a type of voltage signal.

As the voltage level shift circuit, the circuit structure 32 can further level up the latched voltage signal and generate output signals (e.g., a positive output signal and a negative output signal OUT/OUTB) corresponding to the following driving voltage range needed for the DAC 34 and the OPAMP 36.

For example, the operation voltage/ground voltage used in the sample register 30 is usually about 1.8V/0V, but the operation voltage/ground voltage used in the DAC 34 and the OPAMP 36 is about 6V/3V or 10V/3V. Therefore, the voltage level shifter function of the circuit structure 32 is used to overcome the voltage difference between the sample register 30 and the DAC 34/OPAMP 36.

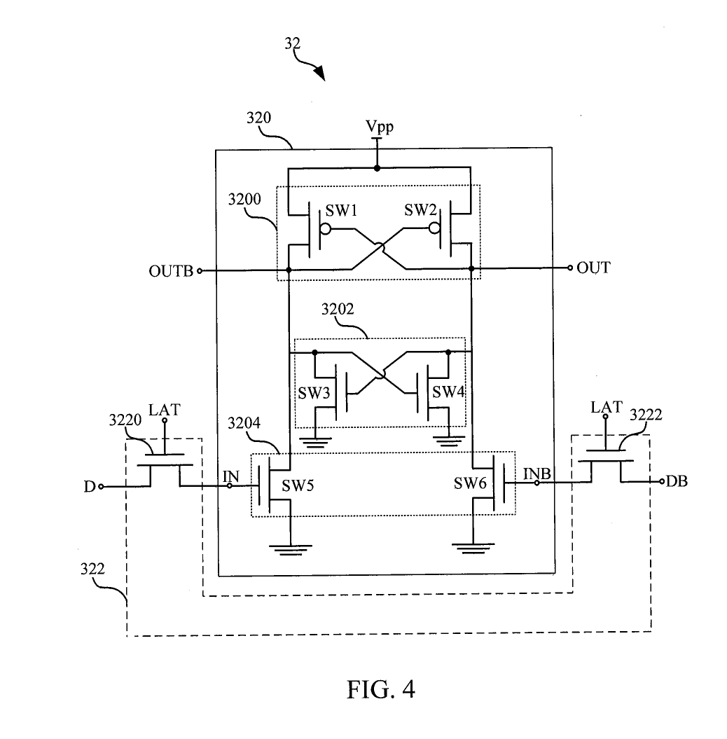

Please also refer to FIG. 4. FIG. 4 illustrates a schematic diagram of the inner circuit of the circuit structure 32 in the first embodiment of the invention. As shown in FIG. 4, the circuit structure 32 includes a multi-function switch circuit 320 and a control module 322.

The multi-function switch circuit 320 is coupled to an elevation voltage terminal Vpp and a system ground terminal. In general, the voltage level of the elevation voltage terminal Vpp is higher than that of a system high-voltage terminal Vdd (Vdd is usually about 1.8V). The voltage level of the elevation voltage terminal Vpp corresponds to the operation voltages used in the DAC 34 and the OPAMP 36. The multi-function switch circuit 320 has a positive input pole IN, a negative input pole INB, a positive output pole OUT, and a negative output pole OUTB.

As shown in FIG. 4, the multi-function switch circuit 320 includes a first switch module 3200, a second switch module 3202, and a third switch module 3204.

The first switch module 3200 includes a first transistor switch SW1 and a second transistor switch SW2. The first transistor switch SW1 is coupled between the elevation voltage terminal Vpp and the negative output pole OUTB, and the gate of the first transistor switch SW1 is coupled to the positive output pole OUT; the second transistor switch SW2 is coupled between the elevation voltage terminal Vpp and the positive output pole OUT, and the gate of the second transistor switch SW2 is coupled to the negative output pole OUTB. The first switch module 3200 is used for selectively coupling the elevation voltage terminal Vpp to the positive output pole OUT or the negative output pole OUTB.

The second switch module 3202 includes a third transistor switch SW3 and a fourth transistor switch SW4. The third transistor switch SW3 is coupled between the negative output pole OUTB and the system ground terminal, and the gate of the third transistor switch SW3 is coupled to the positive output pole OUT; the fourth transistor switch SW4 is coupled between the positive output pole OUT and the system ground terminal, and the gate of the fourth transistor switch SW4 is coupled to the negative output pole OUTB. The second switch module 3202 is used for selectively coupling the system ground terminal to the positive output pole OUT or the negative output pole OUTB.

The third switch module 3204 includes a fifth transistor switch SW5 and a sixth transistor switch SW6. The fifth transistor switch SW5 is coupled between the negative output pole OUTB and the system ground terminal, and the gate of the fifth transistor switch SW5 is coupled to the positive input pole IN; the sixth transistor switch SW6 is coupled between the positive output pole OUT and the system ground terminal, and the gate of the sixth transistor switch SW6 is coupled to the negative input pole INB. The third switch module SW3 is controlled by the positive input pole IN and the negative input pole INB, and used for selectively coupling the positive output pole OUT or the negative output pole OUTB to the system ground terminal.

In this embodiment, the first transistor switch SW1 and the second transistor switch SW2 are P-type field-effect transistors, and the third transistor switch SW3, the fourth transistor switch SW4, the fifth transistor switch SW5, and the sixth transistor switch SW6 are N-type field-effect transistors, but the invention is not limited by these cases.

The control module 322 is coupled to the positive input pole IN and the negative input pole INB. In this embodiment, the control module 322 includes a first control switch module 3220 and a second control switch module 3222. The first control switch module 3220 and the second control switch module 3222 are couple to the gate of the fifth transistor switch SW5 and the gate of the sixth transistor switch SW6 respectively. The first control switch module 3220 and the second control switch module 3222 selectively conduct the positive input signal D and the negative input signal DB to the positive input pole IN and the negative input pole INB respectively according to the latch control signal LAT.

In this embodiment, the first control switch module 3220 and the second control switch module 3222 include a transistor switch device respectively, but the invention is not limited by this case. In another embodiment, the first control switch module 3220 and the second control switch module 3222 include a switch module formed by a plurality of transistor switches or a tri-state switch.

In this embodiment, when the latch control signal LAT is at high voltage level, the first control switch module 3220 and the second control switch module 3222 are conducted respectively. By doing so, the control module 322 inputs the positive input signal D and the negative can input signal DB to the positive input pole IN and the negative input pole INB respectively.

At this time, the first switch module 3200 and the third switch module 3204 form a voltage level shifter circuit.

If the positive input pole IN is at high voltage level and the negative input pole INB is at low voltage level, then the voltage level shifter circuit will conduct the elevation voltage terminal Vpp to the positive output pole OUT to output an elevation voltage output signal, and make the negative output pole OUTB coupled to the system ground terminal.

On the other hand, if the positive input pole IN is at low voltage level and the negative input pole INB is at high voltage level, then the voltage level shifter circuit will make the positive output pole OUT coupled to the system ground terminal, and conduct the elevation voltage terminal Vpp to the negative output pole OUTB to output the elevation voltage output signal.

In this embodiment, the voltage level shifter circuit is a voltage level pull-up circuit used for selectively outputting the elevation voltage output signal via the positive output pole OUT or the negative output pole OUTB based on the voltage level of the elevation voltage terminal Vpp according to the positive input signal D and the negative input signal DB. In general, the voltage level of the elevation voltage terminal Vpp is higher than the voltage level of the positive input signal D or the negative input signal DB.

In addition, when the latch control signal LAT is at low voltage level, the first control switch module 3220 and the second control switch module 3222 are shut down respectively. By doing so, the control module 322 can make the positive input pole IN and the negative input pole INB floating according to the latch control signal LAT. At this time, the first switch module 3200 and the second switch module 3202 will form a data latching circuit used for latching the voltage level of the positive output pole OUT and the voltage level of the negative output pole OUTB, so that the voltage level of the positive output pole OUT and the voltage level of the negative output pole OUTB can be stably maintained.

In the above-mentioned first embodiment of the invention, the control module can switch between the voltage level shifter function and the data latching function by controlling the positive input pole IN and the negative input pole INB of the multi-function switch circuit 320 to be conducted to the input signal or floating, to further achieve the effect of multi-function integrated circuit, but the invention is not limited by these cases. In other embodiments, the control module 322 can directly achieve a data latching function similar to the above-mentioned data latching function when the positive input pole IN and the negative input pole INB are floated without controlling the connecting relationship between the positive input pole IN/the negative input pole INB and the input signal.

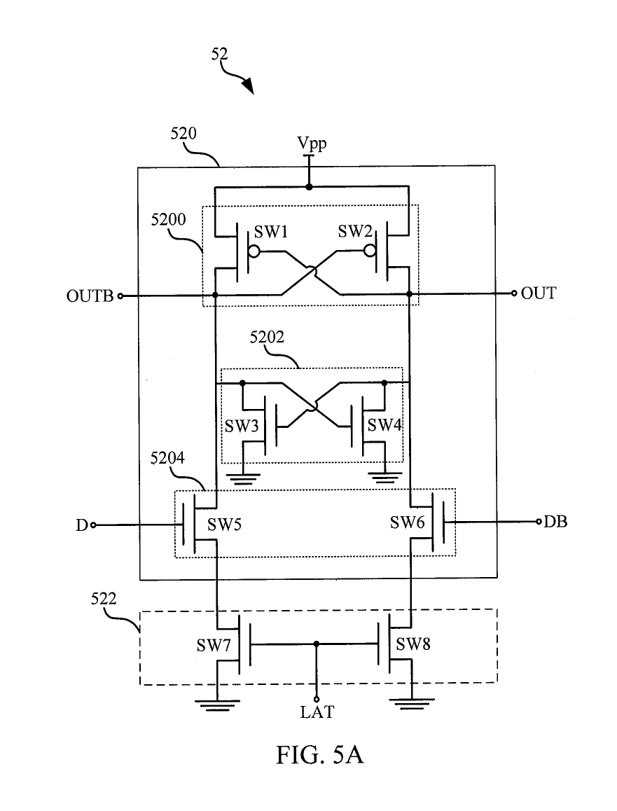

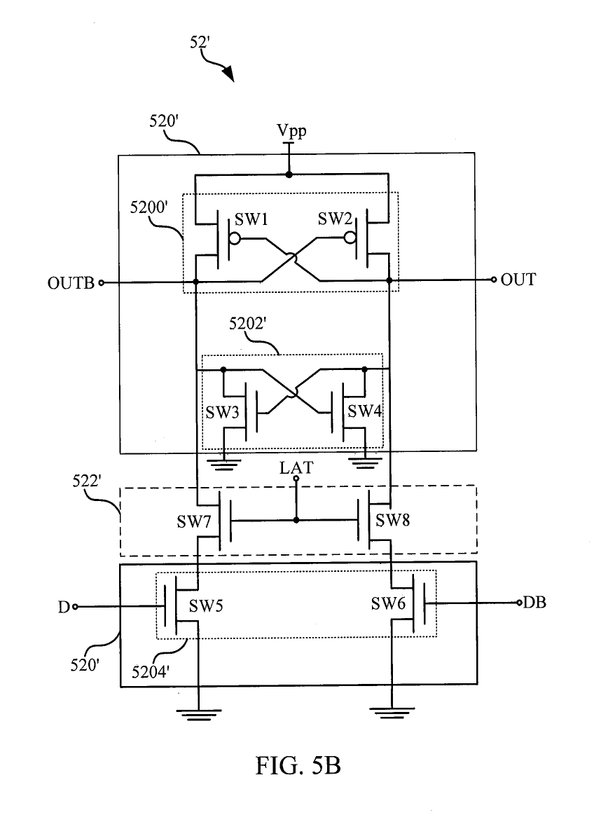

Please refer to FIG. 5A and FIG. 5B. FIG. 5A illustrates a schematic diagram of the inner circuit of the circuit structure 52 in the second embodiment of the invention. FIG. 5B illustrates a schematic diagram of the inner circuit of the circuit structure 52′ in the third embodiment of the invention.

As shown in FIG. 5A, the circuit structure 52 includes a multi-function switch circuit 520 and a control module. The most important difference between this embodiment and the above-mentioned first embodiment is that the control module of this embodiment includes a fourth switch module 522, and the fourth switch module 522 is coupled between the third switch module 5204 and the system ground terminal.

In this embodiment, the fourth switch module 522 includes a seventh transistor switch SW7 and an eighth transistor switch SW8. The seventh transistor switch SW7 is coupled between the fifth transistor switch SW5 and the system ground terminal, and the gate of the seventh transistor switch SW7 is coupled to the latch control signal LAT; the eighth transistor switch SW8 is coupled between the sixth transistor switch SW6 and the system ground terminal, and the gate of the eighth transistor switch SW8 is coupled to the latch control signal LAT. The third transistor switch SW3 and the fourth transistor switch SW4 of the third switch module 5204′ are directly coupled to the positive input signal D and the negative input signal DB.

The control module selectively conducts or shuts down the fourth switch module 522 according to the latch control signal LAT, so that the positive output pole OUT and the negative output pole OUTB can be coupled to the system ground terminal or floated via the third switch module 5204 and the fourth switch module 522. By doing so, the voltage level shifting function and the data latching function can be achieved respectively.

Since the operation methods and components of the circuit structure 52 are approximately the same with those of the first embodiment, they will not be repeated here.

As shown in FIG. 5B, the circuit structure 52′ includes a multi-function switch circuit 520′ and a control module. The most important difference between this embodiment and the above-mentioned first and second embodiments is that the control module of this embodiment includes a fourth switch module 522′, and the fourth switch module 522′ is coupled among the positive output pole OUT, the negative output pole OUTB, and the third switch module 5204′.

The control module selectively conducts or shuts down the fourth switch module 522′ according to the latch control signal LAT, so that the positive output pole OUT and the negative output pole OUTB can be coupled to the system ground terminal or floated via the third switch module 5204′ and the fourth switch module 522′. By doing so, the voltage level shifting function and the data latching function can be achieved respectively. Since the operation methods and components of the circuit structure 52 are approximately the same with those of the first embodiment, they will not be repeated here.

Above all, the circuit structure of the invention is simple and integrates at least two functions of voltage level shifting and data latching, therefore, it is suitable to be applied in various kinds of source driver circuits.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A circuit structure, applied in a source driver circuit, the source driver circuit comprising a sample register and a digital-to-analog converter, the circuit structure being coupled between the sample register and the digital-to-analog converter, the circuit structure comprising:
a multi-function switch circuit, coupled to an elevation voltage terminal and a system ground terminal, having a positive input pole, a negative input pole, and a positive output pole; and
a control module, coupled to the positive input pole and the negative input pole, the control module selectively conducting a positive input signal and a negative input signal from the sample register to the positive input pole and the negative input pole respectively according to a latch control signal;
wherein the multi-function switch circuit controls an output state of the positive output pole according to the positive input signal and the negative input signal conducted to the positive input pole and the negative input pole, if the positive input pole is at high voltage level and the negative input pole is at low voltage level, the multi-function switch circuit conducts the elevation voltage terminal to the positive output pole to output an elevation voltage output signal; if the positive input pole is at low voltage level and the negative input pole is at high voltage level, the multi-function switch circuit conducts the system ground terminal to the positive output pole; when the control module floats the positive input pole and the negative input pole according to the latch control signal, the multi-function switch circuit is used for latching the voltage level of the positive output pole.

2. The circuit structure of claim 1, wherein the multi-function switch circuit further has a negative output pole, the multi-function switch circuit comprises:
a first switch module, for selectively coupling the elevation voltage terminal to the positive output pole or the negative output pole;
a second switch module, for selectively coupling the system ground terminal to the positive output pole or the negative output pole; and
a third switch module, controlled by the positive input pole and the negative input pole, for selectively coupling the positive output pole or the negative output pole to the system ground terminal.

3. The circuit structure of claim 2, wherein when the control module conducts the positive input signal and the negative input signal to the positive input pole and the negative input pole respectively according to a latch control signal, the first switch module and the third switch module form a voltage level shifter circuit, if the positive input pole is at high voltage level and the negative input pole is at low voltage level, the voltage level shifter circuit conducts the elevation voltage terminal to the positive output pole to output the elevation voltage output signal and makes the negative output pole coupled to the system ground terminal; if the positive input pole is at low voltage level and the negative input pole is at high voltage level, the voltage level shifter circuit makes the positive output pole coupled to the system ground terminal and conducts the elevation voltage terminal to the negative output pole to output the elevation voltage output signal.

4. The circuit structure of claim 3, wherein the voltage level shifter circuit is a voltage level pull-up circuit used for selectively outputting the elevation voltage output signal via the positive output pole or the negative output pole based on the voltage level of the elevation voltage terminal according to the positive input signal and the negative input signal, wherein the voltage level of the elevation voltage terminal is higher than the voltage level of the positive input signal or the negative input signal.

5. The circuit structure of claim 2, wherein when the control module floats the positive input pole and the negative input pole according to the latch control signal, the first switch module and the second switch module form a data latching circuit used for latching the voltage level of the positive output pole and the voltage level of the negative output pole.

6. The circuit structure of claim 2, wherein the first switch module comprises:
a first transistor switch, coupled between the elevation voltage terminal and the negative output pole, having a gate coupled to the positive output pole; and
a second transistor switch, coupled between the elevation voltage terminal and the positive output pole, having a gate coupled to the negative output pole;
the second switch module comprises:
a third transistor switch, coupled between the negative output pole and the system ground terminal, having a gate coupled to the positive output pole; and
a fourth transistor switch, coupled between the positive output pole and the system ground terminal, having a gate coupled to the negative output pole; and
the third switch module comprises:
a fifth transistor switch, coupled between the negative output pole and the system ground terminal, having a gate coupled to the positive input pole; and
a sixth transistor switch, coupled between the positive output pole and the system ground terminal, having a gate coupled to the negative input pole.

7. The circuit structure of claim 6, wherein the first transistor switch and the second transistor switch are P-type field-effect transistors, and the third transistor switch, the fourth transistor switch, the fifth transistor switch, and the sixth transistor switch are N-type field-effect transistors.

8. The circuit structure of claim 6, wherein the control module comprises a first control switch module and a second control switch module, the first control switch module and the second control switch module are coupled to the gate of the fifth transistor switch and the gate of the sixth transistor switch respectively, the first control switch module and the second control switch module selectively conduct the positive input signal and the negative input signal to the positive input pole and the negative input pole respectively according to the latch control signal.

9. The circuit structure of claim 8, wherein the first control switch module and the second control switch module comprise at least one transistor or a tri-state switch respectively.

10. A circuit structure, applied in a source driver circuit, the source driver circuit comprising a sample register and a digital-to-analog converter, the circuit structure being coupled between the sample register and the digital-to-analog converter, the circuit structure comprising:
a multi-function switch circuit, having a positive input pole and a negative input pole, the multi-function switch circuit comprising:
a first switch module, for selectively coupling an elevation voltage terminal to the positive output pole or the negative output pole;
a second switch module, for selectively coupling a system ground terminal to the positive output pole or the negative output pole; and
a third switch module, controlled by a positive input signal and a negative input signal from the sample register, for selectively coupling the positive output pole or the negative output pole to the system ground terminal; and
a control module, comprising a fourth switch module coupled between the third switch module and the system ground terminal or coupled among the positive output pole, the negative output pole, and the third switch module, the control module selectively conducting or shutting down the fourth switch module according to a latch control signal to make the positive output pole and the negative output pole capable of coupling to the system ground terminal via the third switch module and the fourth switch module or floating;
wherein when the control module conducts the fourth switch module according to the latch control signal, the third switch module controls output states of the positive output pole and the negative output pole according to the positive input signal and the negative input signal, if the positive input pole is at high voltage level and the negative input pole is at low voltage level, the multi-function switch circuit conducts the elevation voltage terminal to the positive output pole to output an elevation voltage output signal; if the positive input pole is at low voltage level and the negative input pole is at high voltage level, the multi-function switch circuit conducts the system ground terminal to the positive output pole; when the control module shuts down the fourth switch module according to the latch control signal, the first switch module and the second switch module are used for latching the voltage level of the positive output pole and the voltage level of the negative output pole.

11. The circuit structure of claim 10, wherein when the control module conducts the fourth switch module according to the latch control signal, the first switch module and the third switch module form a voltage level shifter circuit, if the positive input pole is at high voltage level and the negative input pole is at low voltage level, the voltage level shifter circuit conducts the elevation voltage terminal to the positive output pole to output the elevation voltage output signal and makes the negative output pole coupled to the system ground terminal; if the positive input pole is at low voltage level and the negative input pole is at high voltage level, the voltage level shifter circuit makes the positive output pole coupled to the system ground terminal and conducts the elevation voltage terminal to the negative output pole to output the elevation voltage output signal.

12. The circuit structure of claim 11, wherein the voltage level shifter circuit is a voltage level pull-up circuit used for selectively outputting the elevation voltage output signal via the positive output pole or the negative output pole based on the voltage level of the elevation voltage terminal according to the positive input signal and the negative input signal, wherein the voltage level of the elevation voltage terminal is higher than the voltage level of the positive input signal or the negative input signal.

13. The circuit structure of claim 10, wherein the first switch module comprises:
a first transistor switch, coupled between the elevation voltage terminal and the negative output pole, having a gate coupled to the positive output pole; and
a second transistor switch, coupled between the elevation voltage terminal and the positive output pole, having a gate coupled to the negative output pole;
the second switch module comprises:
a third transistor switch, coupled between the negative output pole and the system ground terminal, having a gate coupled to the positive output pole; and
a fourth transistor switch, coupled between the positive output pole and the system ground terminal, having a gate coupled to the negative output pole;
the third switch module comprises:
a fifth transistor switch, coupled to the negative output pole, having a gate controlled by the positive input signal; and
a sixth transistor switch, coupled to the positive output pole, having a gate controlled by the negative input signal; and
the fourth switch module comprises:
a seventh transistor switch, coupled between the fifth transistor switch and the system ground terminal, having a gate coupled to the latch control signal; and
an eighth transistor switch, coupled between the sixth transistor switch and the system ground terminal, having a gate coupled to the latch control signal.

14. The circuit structure of claim 10, wherein the first switch module comprises:
a first transistor switch, coupled between the elevation voltage terminal and the negative output pole, having a gate coupled to the positive output pole; and
a second transistor switch, coupled between the elevation voltage terminal and the positive output pole, having a gate coupled to the negative output pole;
the second switch module comprises:
a third transistor switch, coupled between the negative output pole and the system ground terminal, having a gate coupled to the positive output pole; and
a fourth transistor switch, coupled between the positive output pole and the system ground terminal, having a gate coupled to the negative output pole;
the third switch module comprises:
a fifth transistor switch, coupled to the system ground terminal, having a gate controlled by the positive input signal; and
a sixth transistor switch, coupled to the system ground terminal, having a gate controlled by the negative input signal; and
the fourth switch module comprises:
a seventh transistor switch, coupled between the negative output pole and the fifth transistor switch, having a gate coupled to the latch control signal; and
an eighth transistor switch, coupled between the positive output pole and the sixth transistor switch, having a gate coupled to the latch control signal.

15. The circuit structure of claim 14, wherein the first transistor switch and the second transistor switch are P-type field-effect transistors, and the third transistor switch, the fourth transistor switch, the fifth transistor switch, the sixth transistor switch, the seventh transistor switch, and the eighth transistor switch are N-type field-effect transistors.
